(19) United States
(12) Patent Application Publication
(10) Pub. No.: US 2019/0336393 A1
(43) Pub. Date: Nov. 7, 2019

(54) DRUG VIAL ADAPTER ASSEMBLAGES INCLUDING VENTED DRUG VIAL ADAPTER AND VENTED LIQUID VIAL ADAPTER

(71) Applicant: West Pharma. Services IL, Ltd., Ra'anana (IL)

(72) Inventors: Igor DENENBURG, Gedera (IL); Amir LEV, Kfar Saba (IL); Uri DAVID, Nes Ziona (IL)

(21) Appl. No.: 16/303,457

(22) PCT Filed: May 11, 2017
(86) PCT No.: PCT/IL2017/050527

§ 371 Date: Nov. 20, 2018

(30) Foreign Application Priority Data
May 24, 2016 (IL) 245803

(51) Int. Cl. A61J 1/20; A61J 1/14

(52) U.S. Cl. CPC A61J 1/2096; A61J 1/2082; A61J 1/2041; A61J 1/1406; A61J 1/201; A61J 1/2075; A61J 1/2048

(57) ABSTRACT

Dual vial adapter assemblage for use with a drug vial and a liquid vial and including a vented drug vial adapter and a vented liquid vial adapter such that simultaneous venting of the liquid vial and the drug vial assists gravitational flow of liquid contents from the liquid vial into the drug vial for forming liquid drug therein.

### FIELD OF THE INVENTION

The invention relates to dual vial adapter assemblages for use with a drug vial containing a medicament and a liquid vial containing liquid contents.

### BACKGROUND OF THE INVENTION

Dual vial adapter assemblages for use with a drug vial containing a medicament and a liquid vial containing liquid contents for mixing with or reconstituting the medicament in the drug vial to form a liquid drug include a liquid vial adapter for telescopic mounting on the liquid vial and a drug vial adapter for telescopic mounting on the drug vial. Dual vial adapter assemblages can be generally classified into two types as follows: A negative pressure type intended to be used with a drug vial under negative pressure for positively drawing liquid contents from a liquid vial thereinto. A gravitational flow type employing a gravitational flow of liquid contents from a liquid vial to a drug vial. The former type is generally intended for preparing a small liquid drug dosage and the latter type is generally intended for preparing a large liquid drug volume suitable for administration of several small liquid drug dosages or use with an IV infusion set.

One exemplary negative pressure type of dual vial adapter assemblage is disclosed in commonly owned U.S. Pat. No. 6,558,365 to Zinger et al. entitled Fluid Transfer Device including a liquid vial adapter having a male connector and a drug vial adapter having a female connector. The male connector is preferably a male Luer lock connector and the female connector is preferably a female Luer connector with a screw thread for screw thread attachment of a male Luer lock connector thereon. Such dual vial adapter assemblages are commercially available from West Pharmaceutical Services, Inc., Exton, USA under the registered trademark MIX2VIAL.

Another exemplary negative pressure type of dual vial adapter assemblage is disclosed in commonly owned U.S. Pat. No. 8,684,994 to Lev et al. entitled Fluid Transfer Assembly with Venting Arrangement. The dual vial adapter assemblage includes a vented female vial adapter and a male vial adapter. The vented female vial adapter includes a venting arrangement and the male vial adapter includes a sealing arrangement for selectively sealing the venting arrangement. The dual vial adapter assemblage is designed such that only filtered air is drawn into a drug vial under negative pressure subsequent to reconstitution of liquid drug contents to ensure sterile conditions.

The negative pressure type of dual vial adapter assemblages specifically requires a user to initially telescopically mount a liquid vial adapter on a liquid vial and only thereafter telescopically mount a drug vial adapter on a drug vial otherwise negative pressure is lost thereby rendering the dual vial adapter assemblage inoperable. Leakage of negative pressure or insufficient negative pressure may lead to insufficient drawing of liquid contents from a liquid vial to a drug vial.

One exemplary gravitational flow type of dual vial adapter assemblage is disclosed in commonly owned U.S. Pat. No. 8,752,598 to Denenburg et al. entitled Liquid Drug Transfer Assembly. U.S. Pat. No. '598 FIG. 9 shows a dual vial adapter assemblage including a drug vial adapter with a female connector and a liquid vial adapter with a dual lumen dual ended liquid transfer spike for puncturing both a liquid vial stopper and a drug vial stopper. The dual vial adapter assemblage advantageously does not require a specific order of telescopic mounting on a liquid vial and a drug vial but the gravitational based transfer of the liquid contents from a liquid vial to a drug vial through a dual lumen dual ended liquid transfer spike can take longer compared to positive drawing of liquid contents. Moreover, such dual vial adapter assemblages can suffer from incomplete transfer of liquid contents from a liquid vial to a drug vial.

There is a need for dual vial adapter assemblages for facilitating rapid transfer of entire liquid contents from a liquid vial to a drug vial irrespective of whether a drug vial is under negative pressure.

### SUMMARY OF THE INVENTION

The present invention is directed towards dual vial adapter assemblages including a) a vented drug vial adapter having a dual lumen drug vial stopper puncturing cannula with i) a liquid lumen in flow communication with a drug vial adapter connector and ii) a vented air lumen and b) a vented liquid vial adapter having a dual lumen liquid vial stopper puncturing cannula with i) a liquid lumen in flow communication with a liquid vial adapter connector and ii) a vented air lumen. In a set-up position of the dual vial adapter assemblage, the drug vial adapter connector is in flow communication with the liquid vial adapter connector such that, on initial telescopic mounting the liquid vial adapter on the liquid vial and the drug vial adapter on the drug vial, subsequent disposing of the liquid vial above the drug vial leads to simultaneous venting of the liquid vial through the dual lumen liquid vial stopper puncturing cannula's vented air lumen and the drug vial through the dual lumen drug vial stopper puncturing cannula's vented air lumen for assisting gravitational flow of liquid contents from the liquid vial into the drug vial for forming liquid drug therein. The provision of a vented drug vial adapter and a vented liquid vial adapter ensures rapid transfer of all liquid contents from a liquid vial to a drug vial irrespective of whether a drug vial is under negative pressure.

In one preferred embodiment of dual vial adapter assemblages of the present invention, the drug vial adapter connector is a female connector and the liquid vial adapter connector is a male connector for sealed engagement with the female connector. Accordingly, the dual vial adapter assemblage has a similar construction to the hitherto mentioned Zinger dual vial adapter assemblage except that its drug vial adapter and the liquid vial adapter are vented. The male connector is preferably a male Luer lock connector and the female connector is preferably a female Luer connector.

In additional preferred embodiments of dual vial adapter assemblages of the present invention, both the drug vial adapter and the liquid vial adapter have either a male connector or a female connector. In such cases, the dual vial adapter assemblages include an intermediate dual ended liquid transfer coupler having a pair of opposite coupler ends in the form of either female connectors or male connectors. Accordingly, such dual vial adapter assemblages afford the advantage that both a liquid vial adapter and a drug vial adapter can be equally telescopically mounted on a drug vial or a liquid vial.

The dual vial adapter assemblages of the present invention are preferably provided in a set-up position ready for immediate use on removal from suitable sterile packaging. Alternatively, the dual vial adapter assemblages may require to be assembled by a user before use.

The dual vial adapter assemblages of the present invention intended for preparing a large volume of liquid drug for infusion purposes preferably include vial adapters designed for quick release from a vial as disclosed in PCT International Publication No. WO 2012/150587 entitled Vial Adaptor. Accordingly, a vented drug vial adapter can be readily removed from a drug vial containing a liquid drug thereby exposing its drug vial stopper for insertion of an IV infusion set for infusion of a liquid drug to a patient.

### BRIEF DESCRIPTION OF DRAWINGS

In order to understand the invention and to see how it can be carried out in practice, preferred embodiments will now be described, by way of non-limiting examples only, with reference to the accompanying drawings in which similar parts are likewise numbered, and in which:

FIG. 1 is a pictorial view of an administration set including a needleless syringe, a drug vial, a liquid vial, an IV infusion set, and a dual vial adapter assemblage in accordance with a first preferred embodiment of the present invention;

FIG. 2 is an exploded view of the FIG. 1 dual vial adapter assemblage;

FIG. 3 is a longitudinal cross section of the FIG. 1 dual vial adapter assemblage along line A-A in FIG. 1;

FIG. 4 is a longitudinal cross section of the FIG. 1 dual vial adapter assemblage along line A-A in FIG. 1 showing transfer of liquid contents from a liquid vial to a drug vial;

FIG. 5A to FIG. 5F show the use of the administration set;

FIG. 6 is a perspective view of a dual vial adapter assemblage in accordance with a second preferred embodiment of the present invention;

FIG. 7 is an exploded view of the FIG. 6 dual vial adapter assemblage;

FIG. 8 is a longitudinal cross section of the FIG. 6 dual vial adapter assemblage along line B-B in FIG. 6;

FIG. 9 is a perspective view of a dual vial adapter assemblage in accordance with a third preferred embodiment of the present invention;

FIG. 10 is an exploded view of the FIG. 9 dual vial adapter assemblage; and

FIG. 11 is a longitudinal cross section of the FIG. 9 dual vial adapter assemblage along line C-C in FIG. 9.

### DETAILED DESCRIPTION OF PREFERRED EMBODIMENTS OF THE INVENTION

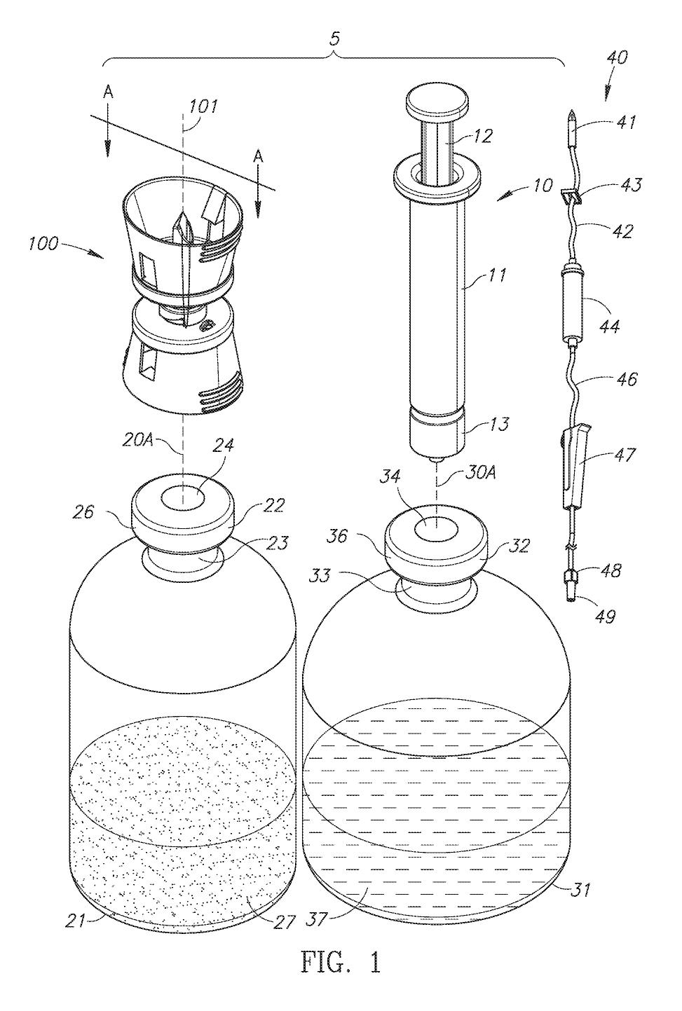

FIG. 1 shows an administration set 5 including an initially empty needleless syringe 10, a drug vial 20, a liquid vial 30, an infusion set 40 (shown in a reduced scale) and a dual vial adapter assemblage 100. The needleless syringe 10 includes a barrel 11 with a plunger 12 and a male Luer lock connector 13. The syringe 10 can be formed with other types of male connectors. The drug vial 20 has a longitudinal drug vial axis 20A and includes an open topped drug vial bottle 21 having a drug vial crown 22 and a narrow diameter drug vial neck 23. The drug vial crown 22 is sealed by a drug vial stopper 24. The drug vial stopper 24 is sealed by an aluminum band 26. The drug vial 20 contains a medicament 27 in the form of a powder, solid or liquid. The liquid vial 30 has a longitudinal liquid vial axis 30A and includes an open topped liquid vial bottle 31 having a liquid vial crown 32 and a narrow diameter drug vial neck 33. The liquid vial crown 32 is sealed by a liquid vial stopper 34. The liquid vial stopper 34 is sealed by an aluminum band 36. The liquid vial 30 includes liquid contents 37 in the form of diluent only or an active component. The IV infusion set 40 includes an IV spike 41, first tubing 42, a clamp 43, a drip chamber 44, second tubing 46, a roller clamp 47, a male Luer connector 48, and a Luer shield 49. First tubing 42 typically have dimensions 4.1 mm×200 mm and second tubing 46 typically have dimensions 4.1 mm and 500 mm.

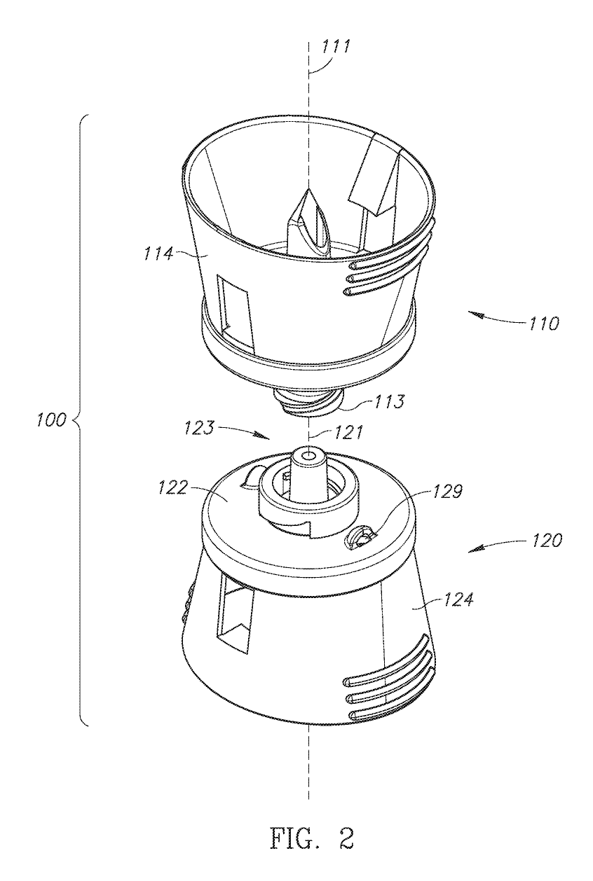

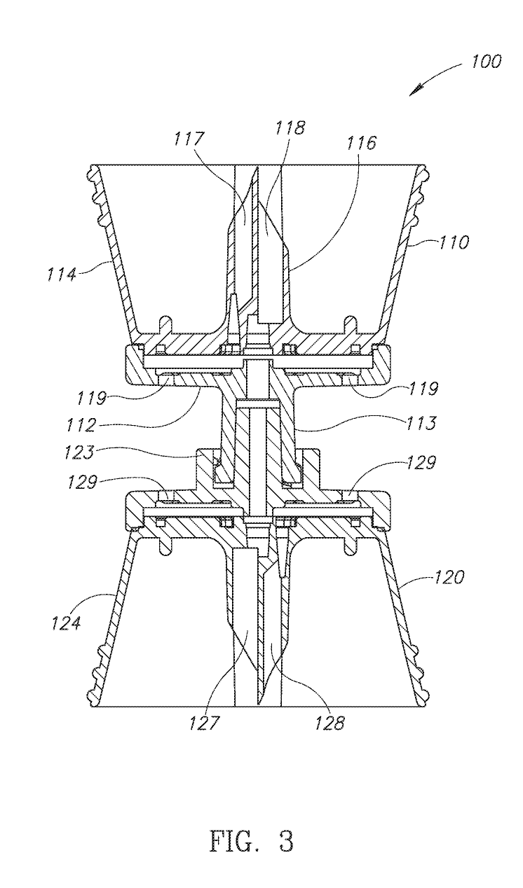

FIGS. 2 and 3 show the dual vial adapter assemblage 100 has a longitudinal dual vial adapter assemblage centerline 101 and includes a vented drug vial adapter 110 and a vented liquid vial adapter 120.

The vented drug vial adapter 110 has a longitudinal drug vial adapter centerline 111 and includes a transverse drug vial adapter top wall 112. The drug vial adapter top wall 112 has an upright drug vial adapter connector 113 preferably constituted by a female Luer connector including an external screw thread for screw thread engagement by a male Luer lock connector. The drug vial adapter top wall 112 has an oppositely directed drug vial adapter skirt 114 for telescopic mounting on the drug vial 20. The drug vial adapter top wall 112 includes a dual lumen drug vial stopper puncturing cannula 116 for puncturing the drug vial stopper 24 on telescopic mounting the vented drug vial adapter 110 on the drug vial 20. The dual lumen drug vial stopper puncturing cannula 116 includes a liquid lumen 117 in flow communication with the drug vial adapter connector 113 and a vented air lumen 118 with throughgoing bores 119 formed in the drug vial adapter top wall 112. The liquid lumen 117 typically has a wider diameter than the vented air lumen 118.

The vented liquid vial adapter 120 has a longitudinal liquid vial adapter centerline 121 and includes a transverse liquid vial adapter top wall 122. The liquid vial adapter top wall 122 has an upright liquid vial adapter connector 123 preferably constituted by a male Luer lock connector for screw thread engagement on the female Luer connector 113. The liquid vial adapter top wall 122 has an oppositely directed liquid vial adapter skirt 124 for telescopic mounting on the liquid vial 30. The liquid vial adapter top wall 122 includes a dual lumen liquid vial stopper puncturing cannula 126 for puncturing the liquid vial stopper 34 on telescopic mounting the vented liquid vial adapter 120 on the liquid vial 30. The dual lumen liquid vial stopper puncturing cannula 126 includes a liquid lumen 127 in flow communication with the liquid vial adapter connector 123 and a vented air lumen 128 with throughgoing bores 129 formed in the liquid vial adapter top wall 122. The liquid lumen 127 typically has a wider diameter than the vented air lumen 128. The liquid vial adapter 120 can optionally include an air filter for filtering incoming air.

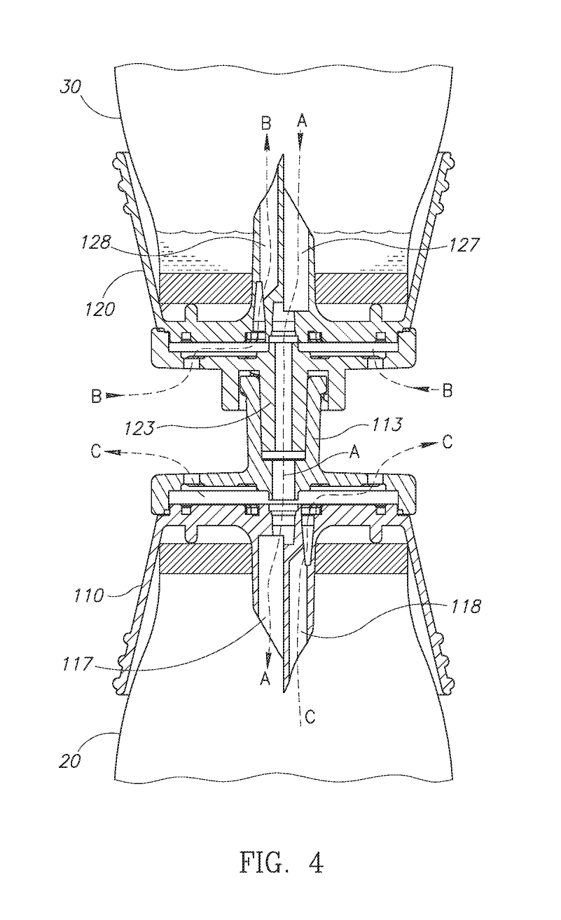

FIG. 4 shows gravitational flow of liquid contents from the liquid vial 30 to the drug vial 20 through the liquid lumen 127, the liquid vial adapter connector 123, the drug vial adapter connector 113 and the liquid lumen 117 as denoted by arrows A. FIG. 4 shows the gravitational flow is facilitated by air being drawn into the liquid vial 30 via the vented air lumen 128 denoted by arrows B and air being expelled from the drug vial 20 via the vented air lumen 118 denoted by the arrows C.

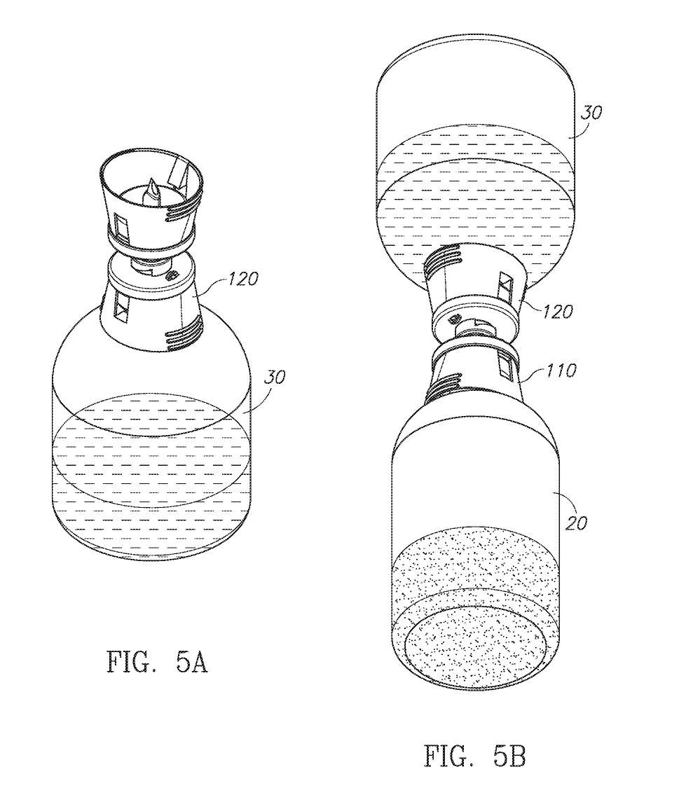

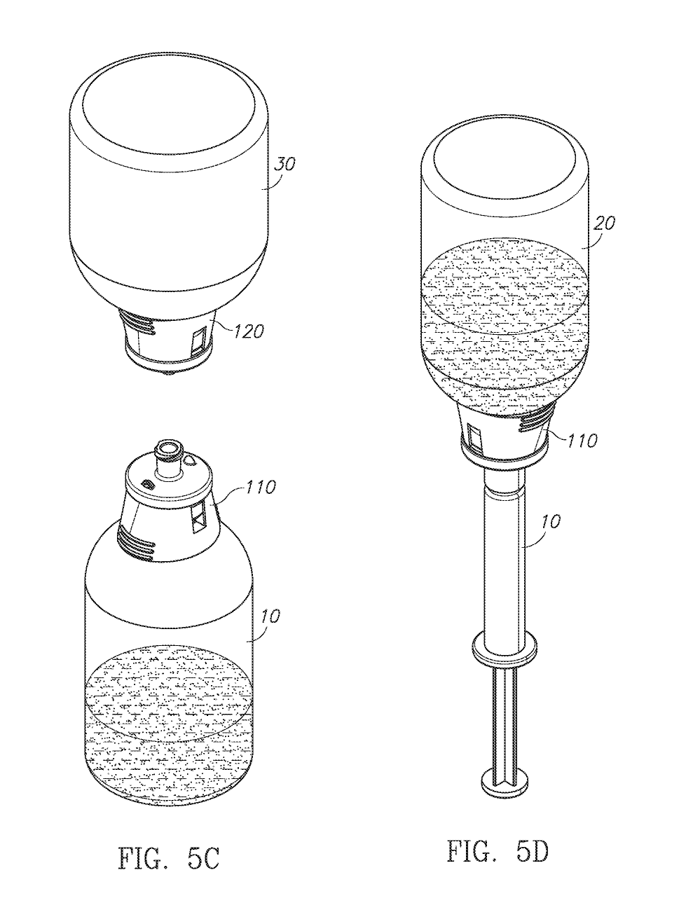

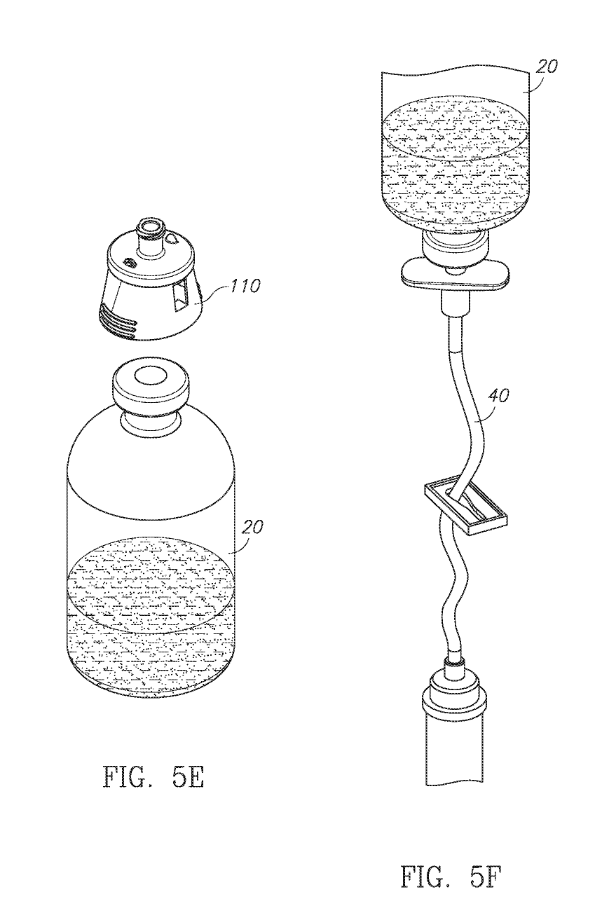

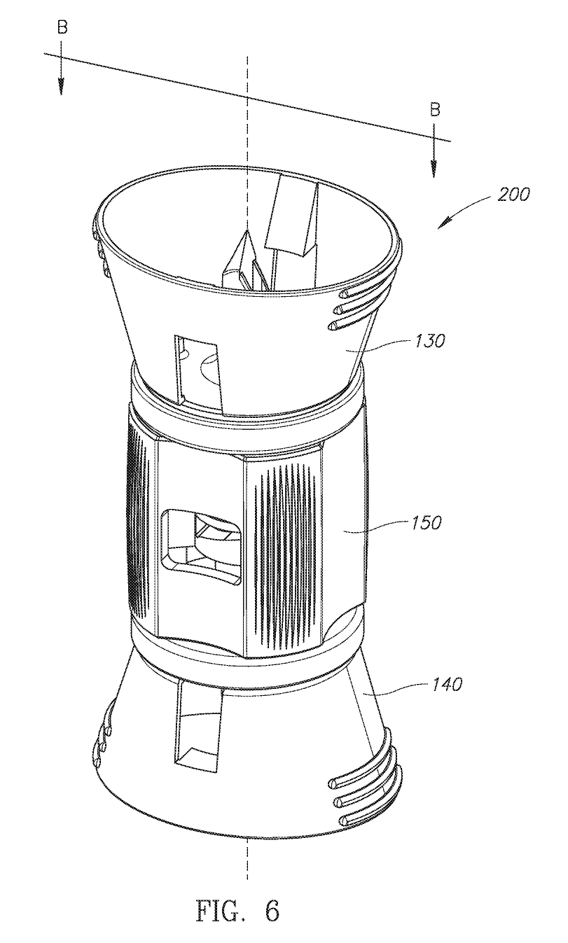

FIG. 5A to FIG. 5F show the use of the administration set 5 for preparing a liquid drug in a drug vial 20 ready for administration to a patient. FIG. 5A shows telescopic mounting the vented liquid vial adapter 120 on the liquid vial 30 for puncturing same. FIG. 5B shows inverting the dual vial adapter assemblage 100 together with the attached liquid vial 30 and telescopically mounting the vented drug vial adapter 110 on the drug vial 20 for puncturing same thereby leading to gravitational flow of liquid contents from the liquid vial 30 to the drug vial 20 to form a liquid drug therein. FIG. 5C shows unscrewing the vented liquid vial adapter 120 from the vented drug vial adapter 110. FIG. 5D shows screwing the syringe 10 onto the vented drug vial adapter 110 for aspirating a liquid drug dosage from the drug vial 20 for administration to a patient. FIG. 5E shows removal of the vented drug vial adapter 110 from the drug vial 20. FIG. 5F shows connection of the IV infusion set 40 to the drug vial 20 for infusion of liquid drug to the patient.

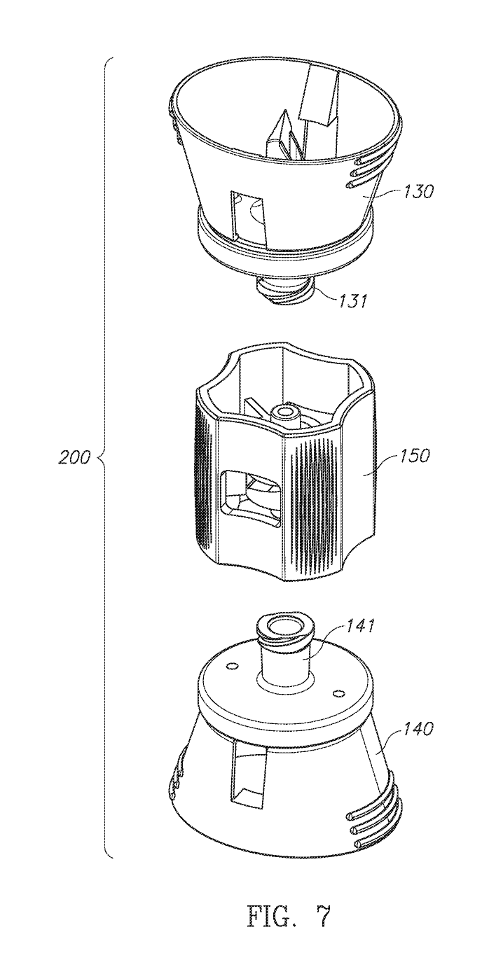

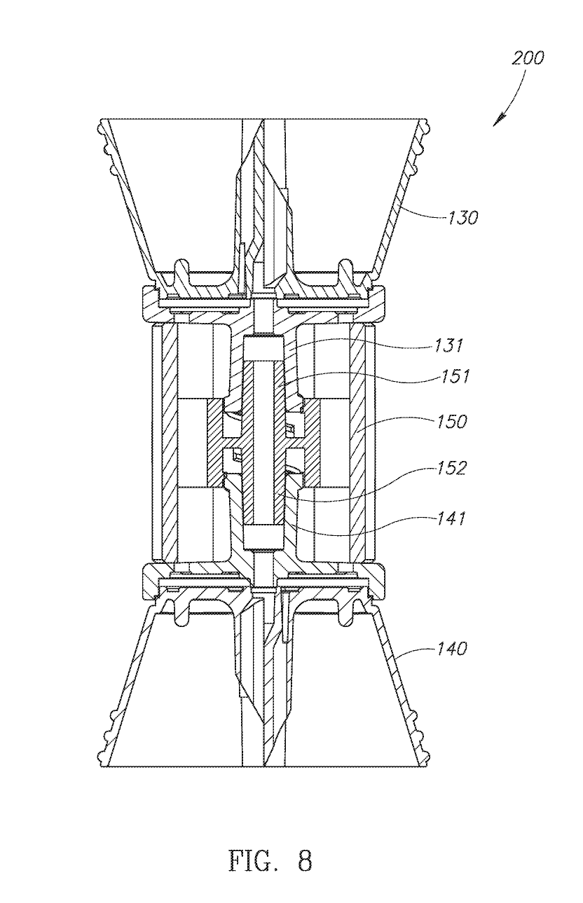

FIG. 6 to FIG. 8 show a dual vial adapter assemblage 200 similar in construction and operation as the dual vial adapter assemblage 100. The latter 200 differs from the former 100 insofar as the latter 200 has a triple component construction as opposed to a dual component construction. The latter 200 includes a vented vial adapter 130, a vented vial adapter 140 and a dual ended liquid transfer coupler 150 intermediate the vented vial adapter 130 and the vented vial adapter 140. Both the vented vial adapter 130 and the vented vial adapter 140 are identical to the vented drug vial adapter 110 and correspondingly include a female Luer connector 131 and a female Luer connector 141. The dual ended liquid transfer coupler 150 is formed with dual opposite male Luer lock connectors 151 and 152 for corresponding sealing inter-engagement with the female Luer connector 131 and the female Luer connector 141.

The use of the dual vial adapter assemblage 200 is the same as the dual vial adapter assemblage 100 except that one of the vented vial adapter 130 and the vented vial adapter 140 can be initially telescopic mounted on a liquid vial 30 and the other available vial adapter of the vented vial adapter 130 and the vented vial adapter 140 subsequently telescopic mounted on a drug vial 20 to prepare a liquid drug therein. Thereafter, the dual ended liquid transfer coupler 150 and the vented vial adapter 130 or the vented vial adapter 140 telescopic mounted on the empty liquid vial 30 are removed for enabling use from FIG. 5C onwards.

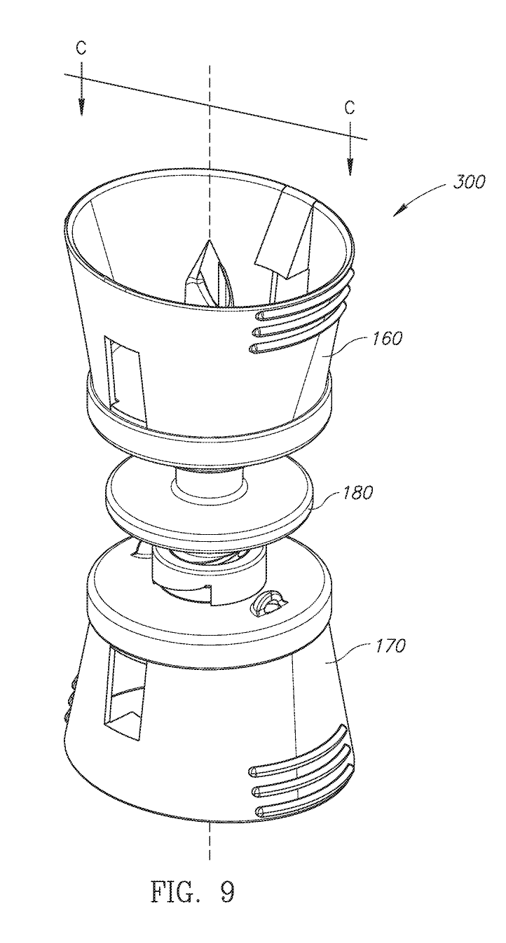

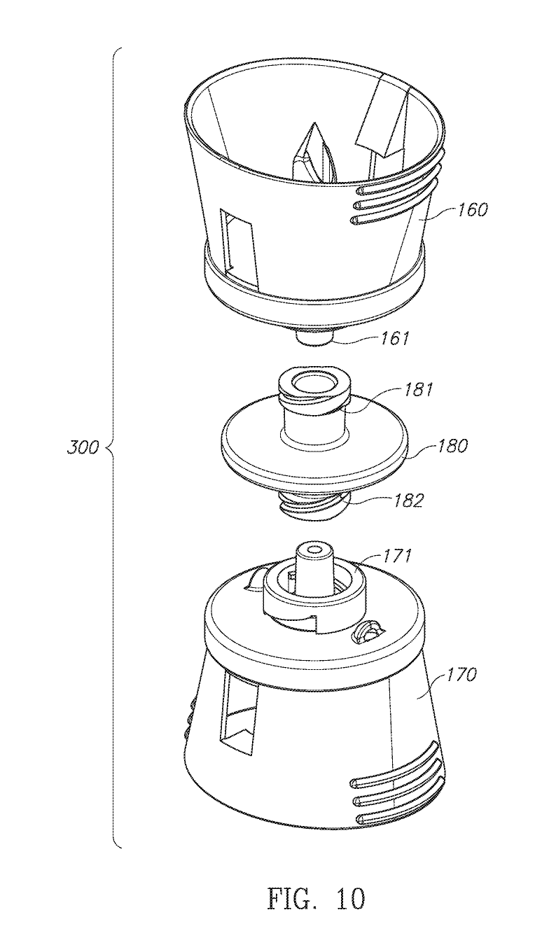

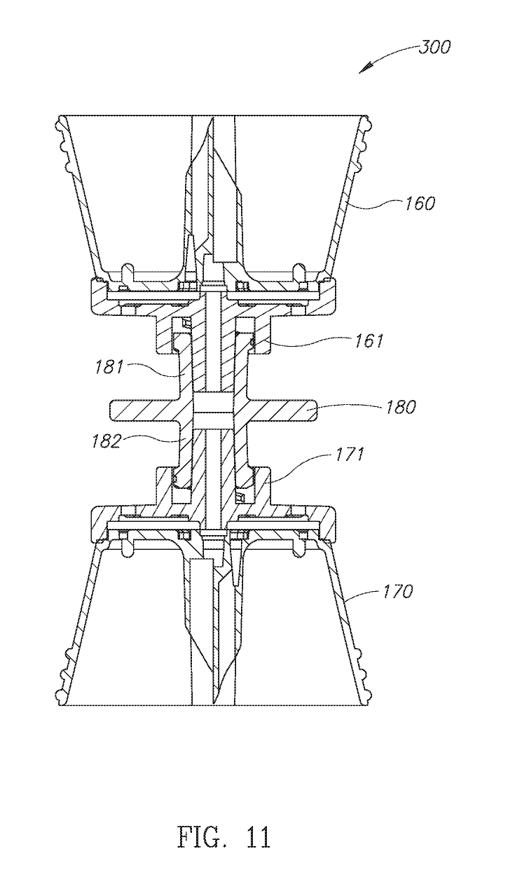

FIG. 9 to FIG. 11 show a dual vial adapter assemblage 300 similar in construction and operation as the dual vial adapter assemblage 200. The latter 300 differs from the former 200 insofar as the latter 300 include a vented vial adapter 160 and a vented vial adapter 170 identical to the vented liquid vial adapter 120 and correspondingly include a male Luer lock connector 161 and a male Luer lock connector 171. Correspondingly, the latter 300 includes a dual ended liquid transfer coupler 180 formed with dual opposite female Luer connectors 181 and 182 for corresponding sealing inter-engagement with the male Luer lock connector 161 and the male Luer lock connector 171.

The use of the dual vial adapter assemblage 300 is the same as the dual vial adapter assemblage 200 except that the dual ended liquid transfer coupler 180 is left attached to either the vented vial adapter 160 or the vented vial adapter 170 telescopically mounted on a drug vial 20 containing a liquid drug ready for syringe aspiration and/or infusion.

While particular embodiments of the present invention are illustrated and described, it would be obvious to those skilled in the art that various other changes and modifications can be made without departing from the spirit and scope of the invention.

1-4. (canceled)

5. A dual vial adapter assemblage for use with a drug vial, a liquid vial and a needleless syringe, the drug vial having a drug vial bottle and a drug vial stopper sealing the drug vial bottle, the drug vial containing a medicament, the liquid vial having a liquid vial bottle and a liquid vial stopper sealing the liquid vial bottle, the liquid vial containing liquid contents for mixing with or reconstituting the medicament in the drug vial to form a liquid drug therein, the needleless syringe being empty, the dual vial adapter assemblage having a longitudinal dual vial adapter assemblage centerline and comprising:
a vented drug vial adapter having a longitudinal drug vial adapter centerline and including a transverse drug vial adapter top wall with an upright drug vial adapter connector, an oppositely directed drug vial adapter skirt for telescopic mounting on the drug vial, and a dual lumen drug vial stopper puncturing cannula for puncturing the drug vial stopper on said telescopic mounting said vented drug vial adapter on the drug vial, said dual lumen drug vial stopper puncturing cannula having i) a liquid lumen in flow communication with said drug vial adapter connector and ii) a vented air lumen openly vented to the ambient surroundings; and
a vented liquid vial adapter having a longitudinal liquid vial adapter centerline and including a transverse liquid vial adapter top wall with an upright liquid vial adapter connector, an oppositely directed liquid vial adapter skirt for telescopic mounting on the liquid vial, and a dual lumen liquid vial stopper puncturing cannula for puncturing the liquid vial stopper on said telescopic mounting said vented liquid vial adapter on the liquid vial, said dual lumen liquid vial stopper puncturing cannula having i) a liquid lumen in flow communication with said liquid vial adapter connector and ii) a vented air lumen openly vented to the ambient surroundings,
the vented drug vial adapter and the vented liquid vial adapter being formed as discrete components,
the arrangement being such that in a set-up position of the dual vial adapter assemblage in which said drug vial adapter connector is connected to, and in flow communication with said liquid vial adapter connector, on initial telescopic mounting said vented liquid vial adapter on the liquid vial and said vented drug vial adapter on the drug vial, subsequent disposing of the liquid vial above the drug vial leads to gravitational flow of liquid contents from the liquid vial to the drug vial for forming the liquid drug therein assisted by simultaneous venting of the liquid vial by drawing ambient air thereinto through said dual lumen liquid vial stopper puncturing cannula's vented air lumen and the drug vial by expelling air therefrom through said dual lumen drug vial stopper puncturing cannula's vented air lumen to the ambient surroundings,
the drug vial adapter being detachable from the liquid vial adapter for providing access to the drug vial adapter connector for enabling connection of the empty needless syringe thereto for aspiring a liquid drug dosage from the drug vial for administration to a patient.

6. The assemblage according to claim 5 wherein said liquid vial adapter connector is a male connector and said drug vial adapter connector is a female connector for direct sealed engagement with said male connector.

7. The assemblage according to claim 5 wherein each of said liquid vial adapter connector and said drug vial adapter connector is a female connector and the dual vial adapter assemblage further comprises a dual ended liquid transfer coupler having a pair of opposite coupler ends in the form of male connectors for sealed engagement with said liquid vial adapter connector and said drug vial adapter connector in said set-up position.

8. The assemblage according to claim 5 wherein each of said liquid vial adapter connector and said drug vial adapter connector is a male connector and the dual vial adapter assemblage further comprises a dual ended liquid transfer coupler having a pair of opposite coupler ends in the form of female connectors for sealed engagement with said liquid vial adapter connector and said drug vial adapter connector in said set-up position.
